(19) United States
(12) Patent Application Publication
(10) Pub. No.: US 2024/0360354 A1
(43) Pub. Date: Oct. 31, 2024

(54) NANOEMULSION AND METHOD FOR PREPARATION THEREOF, AND HIGH-TEMPERATURE-RESISTANT, HIGH-DENSITY, OIL-BASED WELL COMPLETION FLUID AND APPLICATION THEREOF

(71) Applicants: China National Petroleum Corporation, Beijing (CN); CNPC Engineering Technology R&D Company Limited, Beijing (CN)

(72) Inventors: Lili YAN, Beijing (CN); Jianhua WANG, Beijing (CN); Jiaqi ZHANG, Beijing (CN); Fengbao LIU, Beijing (CN); Rongchao CHENG, Beijing (CN); Haijun YANG, Beijing (CN); Xiaobo CUI, Beijing (CN); Xiaoxiao NI, Beijing (CN); Rentong LIU, Beijing (CN); Shan GAO, Beijing (CN)

(21) Appl. No.: 18/759,979

(22) Filed: Jun. 30, 2024

Related U.S. Application Data
(63) Continuation of application No. PCT/CN2022/102987, filed on Jun. 30, 2022.

(30) Foreign Application Priority Data
Dec. 31, 2021 (CN) 202111678426.9

(51) Int. Cl. C09K 8/36; E21B 21/00

(52) U.S. Cl. CPC C09K 8/36; E21B 21/00

(57) ABSTRACT

Provided by the present disclosure are a nanoemulsion and method for its preparation, and a high-temperature-resistant, high-density, oil-based well completion fluid and the application thereof. The nanoemulsion comprises a lipophilic alkenyl monomer, a hydrophilic alkenyl monomer, an emulsifier, a cross-linking agent, and water. The high-temperature-resistant, high-density, oil-based completion fluid comprises a base oil, a main emulsifier, an auxiliary emulsifier, an aqueous solution of salt, organic soil, an alkalinity regulator, a filtrate loss reducer, a stabilizer, and a weighting material. The stabilizer comprises the described nanoemulsion.

### CROSS-REFERENCE TO RELATED APPLICATIONS

This application is a continuation of International Patent Application No. PCT/CN2022/102987. filed on Jun. 30, 2022, which claims priority to Chinese Patent Application No. 202111678426.9. filed on Dec. 31. 2021. both of which are hereby incorporated by reference in their entireties.

### FIELD OF THE INVENTION

The present disclosure relates to a nanoemulsion and a preparation method thereof. a high-temperature-resistant, high-density, oil-based completion fluid and application thereof, and belongs to the field of oil extraction technology.

### BACKGROUND OF THE INVENTION

Of the remaining onshore hydrocarbon resources, both oil and natural gas are distributed in deep and ultra-deep formations, which have become an important area of energy. In particular. the complex geological conditions of the coexistence of high temperature (200° C.), high pressure (200 MPa), a thick salt-gypsum layer (4,500 m) and a high-pressure brine layer (with a pressure coefficient of 2.6) are world-class drilling challenges. At present, the exploration and development further advance to the complex field of a depth of 8000 m or more and multiple salt layers, which also brings about higher challenges to the drilling and completion fluid technology.

In order to meet the difficult drilling demands of the “three-high” oil and gas wells, oil-based drilling fluids with good inhibition, lubrication, thermal stability and anti-pollution properties are commonly used for the drilling, followed by oil-testing and well-completion operations. Deep wells have high downhole temperature, complex well structure, complicated oil testing process, long cycle of lowering completion tubing column, and high process requirements, and have higher requirements for oil testing and completion fluid. Oil-based drilling fluids are in circulating dynamic conditions during operation and are exposed to high temperatures for relatively short periods of time, while completion fluids are in static conditions and are kept still and exposed to high temperatures for up to 10-15 days. Therefore, the existing oil-based drilling fluids cannot be directly used for completion fluids under high-temperature conditions, and there are problems such as high-temperature emulsion-breaking and barite settling under long-time static conditions, which cannot meet the needs of oil testing and completion operations in deep and ultra-deep wells.

At present, most conventional wells still use a brine system for oil testing and completion operations, but the density of organic brine completion fluids is limited (generally not more than 2.3 g/cm³), and the temperature resistance is limited under high-density conditions, and if it is aggravated by using high-density organic salts (e.g., ZnBr₂), it is expensive and at the same time corrosive, which greatly restricts its use in the application of high-temperature, high-pressure and ultra-deep wells. In addition, when the above water-based completion fluid is used in oil testing and completion operations of deep well drilled by an oil-based drilling fluid, there is a large area of contamination of the water-based completion fluid and oil-based drilling fluid during the top-off process, resulting in an increase in the cost of the drilling fluid; further, a high-viscosity isolation fluid needs to be injected into the contact interface, and it is also necessary to consider the high-temperature-resistant performance of the isolation fluid, its compatibility with the water-based completion fluid and the oil-based drilling fluid and the top-off efficiency, increasing the risk of field operation and extending the operation cycle, and seriously affecting the efficiency of the development of the oil and gas fields.

### SUMMARY OF THE INVENTION

In order to solve the above problems, it is an object of the present disclosure to provide a nanoemulsion and a preparation method thereof, a high-temperature-resistant, high-density, oil-based completion fluid and application thereof.

In order to achieve the above object, the present disclosure provides a nanoemulsion, wherein raw materials of the nanoemulsion comprise: a lipophilic alkenyl monomer, a hydrophilic alkenyl monomer, an emulsifier, a cross-linking agent, and water; wherein a mass ratio of the lipophilic alkenyl monomer, the hydrophilic alkenyl monomer, and water is 1:(0.01-0.3):(0.1-5); the mass of the emulsifier is 0.2-7% of the total mass of the lipophilic alkenyl monomer and the hydrophilic alkenyl monomer, and the mass of the cross-linking agent is 1-8% of the total mass of the lipophilic alkenyl monomer and the hydrophilic alkenyl monomer; and the emulsifier comprises a phosphate-based emulsifier.

In a specific embodiment of the present disclosure, the lipophilic alkenyl monomer and hydrophilic alkenyl monomer form an amphiphilic polymer with hydrophilic and lipophilic groups (belonging to olefinic polymers) by emulsion polymerization, and the amphiphilic polymer is cross-linked by a cross-linking agent at the same time, and ultimately forms a nanoemulsion. Said nanoemulsion has amphiphilic properties, which can effectively enhance the oil-water interfacial film strength when applied to an oil-based completion fluid, improve the high-temperature rheology of the completion fluid, and prevent the weighting material from settling after a long period of static storage in a high-temperature environment.

In a specific embodiment of the present disclosure, the preparation method of the nanoemulsion may comprise: mixing and emulsifying the raw materials of the nanoemulsion to obtain a pre-emulsion; taking a part of the pre-emulsion and adding an initiator, reacting in a protective atmosphere, followed by addition the remaining pre-emulsion, heating up, and continuing the reaction to obtain the nanoemulsion.

In the above nanoemulsion, the particle size of the nanoparticles (i.e. cross-linked amphiphilic polymers) in the nanoemulsion is generally 10-300 nm, preferably 10-100 nm.

In the above nanoemulsion, the mass content of the active ingredient (cross-linked amphiphilic polymer) of the nanoemulsion is generally 35% or more.

In a specific embodiment of the present disclosure, the pH of the above nanoemulsion is generally controlled at 7-9.

In the above nanoemulsion, the lipophilic alkenyl monomer is generally a lipophilic alkene and/or a derivative of a lipophilic alkene, and may for example comprise one or a combination of two or more of styrene, p-methyl styrene, α-methylstyrene, and the like.

In the above nanoemulsion, the hydrophilic alkenyl monomer is generally a hydrophilic alkene and/or a derivative of a hydrophilic alkene, and specifically, the hydrophilic alkenyl monomer may comprise an alkenyl compound with a hydrophilic group (carboxyl, hydroxyl, sulphonic acid groups, etc.). For example, the hydrophilic alkenyl monomer may comprise one or a combination of two or more of acrylic acid, methacrylic acid, methyl acrylate, methyl methacrylate, butyl methacrylate, hydroxy ethyl acrylate, butyl acrylate, sodium vinylsulphonate and the like.

According to a specific embodiment of the present disclosure, the mass ratio of the lipophilic alkenyl monomer, the hydrophilic alkenyl monomer, water may be 1:(0.01-0.1):(0.1-5).

In the above nanoemulsion, the emulsifier is a high-temperature-resistant emulsifier, and specifically, the high-temperature-resistant emulsifier may comprise one or a combination of two or more of a phosphate-based emulsifier, such as one or a combination of two or more of alkyl alcohol amide phosphate, imidazoline-based phosphate, alkylphenol sulfonate polyoxyethylene ether phosphate salt, and the like.

According to a specific embodiment of the present disclosure, the mass of the emulsifier is 0.2%-4% of the total mass of the lipophilic alkenyl monomer and the hydrophilic alkenyl monomer.

In the above nanoemulsion, the cross-linking agent is a high-temperature-resistant cross-linking agent, and specifically, the high-temperature-resistant cross-linking agent may be a compound made by reacting divinyl dimethyl silane and diphenyl chloromethane. In a specific embodiment of the present disclosure, the method of preparing the high-temperature-resistant cross-linking agent may comprise: mixing divinyl dimethylsilane and diphenylchloromethane, raising the temperature to 60° C., adding a catalyst, then raising the temperature to 90° C., adding an initiator such as ammonium persulphate and reacting, to obtain said cross-linking agent.

According to a specific embodiment of the present disclosure, the mass of the cross-linking agent may be 1%-8% of the total mass of the lipophilic alkenyl monomer and the hydrophilic alkenyl monomer.

In a specific embodiment of the present disclosure, the above nanoemulsion may further comprise a molecular weight modifier.

In the above nanoemulsion, the molecular weight modifier may comprise one or a combination of two or more of tert-dodecanethiol, n-dodecanethiol and tert-octadecanethiol.

In the above nanoemulsion, the mass of the molecular weight modifier is generally 0.01%-1% of the mass of the lipophilic alkenyl monomer, i.e., the mass ratio of the molecular weight modifier to the lipophilic alkenyl monomer is (0.01-1):100.

According to a specific embodiment of the present disclosure, the above nanoemulsion generally further comprises a pH buffer.

In the above nanoemulsion, the mass of the pH buffer is generally controlled at 0.001%-0.05%, e.g. 0.001%-0.02%, of the mass of the lipophilic alkenyl monomer.

In the above nanoemulsion, the pH buffer may generally comprise one or a combination of two or more of sodium bicarbonate, potassium bicarbonate, ammonium bicarbonate, sodium carbonate, potassium carbonate and ammonium carbonate.

The present disclosure also provides a method of preparing the above nanoemulsion, comprising: mixing and emulsifying the raw materials of the nanoemulsion to obtain a pre-emulsion; taking 25%-35% of the total volume of the pre-emulsion, adding an initiator, and carrying out a first stage reaction in a protective atmosphere; and then adding the remaining pre-emulsion, heating up to carry out a second-stage reaction, and cooling it down to obtain the nanoemulsion.

According to a specific embodiment of the present disclosure, the raw material of the nanoemulsion may further comprise a molecular weight modifier and/or a pH buffer.

In the above method of preparing the nanoemulsion, the initiator generally comprises one or a combination of two or more of potassium persulphate, sodium persulphate, ammonium persulphate and the like.

In the above method of preparing the nanoemulsion, the mass of the initiator is generally controlled at 0.1%-1% of the total mass of said lipophilic alkenyl monomer and hydrophilic alkenyl monomer.

In the above method of preparing the nanoemulsion, the reaction temperature of the first stage reaction is generally controlled at 50-75° C., and the reaction time of the first stage reaction is generally controlled at 0.1-2 h, for example 0.5-2 h.

In the above method of preparing the nanoemulsion, the reaction temperature of the second stage reaction is generally controlled at 70-90° C., and the reaction time of the second stage reaction is generally controlled at 1.5-6 h.

According to a specific embodiment of the present disclosure, the above method of preparing the nanoemulsion may specifically comprise:

1. mixing a lipophilic alkenyl monomer, a hydrophilic alkenyl monomer, an emulsifier, a cross-linking agent, a molecular weight adjusting agent, a pH buffer and water, and emulsifying with high-speed stirring to obtain a pre-emulsion;

2. taking 25%-35% of the total volume of the pre-emulsion, stirring in a protective atmosphere (such as nitrogen atmosphere), slowly raising the temperature to 50-75° C., adding an initiator dropwise, and carrying out the first stage reaction for a reaction time of 0.1-2h;

3. adding the remaining pre-emulsion to the reaction system of step 2, raising the temperature to 70-90° C. for the second stage reaction, controlling the reaction time to 1.5-6 h, cooling, adjusting the pH to 7-9 to obtain the nanoemulsion. The nanoparticles in the nanoemulsion have a particle size of generally 10-300 nm.

The present disclosure also provides a high-temperature-resistant, high-density, oil-based completion fluid comprising, by weight, 200-240 parts of base oil, 2-28 parts of a primary emulsifier, 1-12 parts of a co-emulsifier, 10-60 parts of an aqueous solution of salt, 0.5-10 parts of organic soil, 3-16 parts of an alkalinity regulator, 2-18 parts of a filtrate reducer, 1-16 parts of a stabilizer, and 300-1350 parts of a weighting material; wherein the stabilizer comprises the aforementioned nanoemulsion.

According to a specific embodiment of the present disclosure, the above high-temperature-resistant, high-density, oil-based completion fluid may comprise, by weight: 200-240 parts of base oil, 2-28 parts of a primary emulsifier, 1-12 parts of a co-emulsifier, 10-60 parts of an aqueous solution of salt, 0.5-10 parts of organic soil, 3-16 parts of an alkalinity regulator, 2-18 parts of a filtrate reducer, 1-16 parts of a stabilizer, and 500-1200 parts of a weighting material; wherein the stabilizer comprises the above nanoemulsion.

Existing high-density completion fluids are prone to settlement under high-temperature conditions. In the present disclosure, it has been discovered through research that the causes of the settlement mainly come from two aspects: one is settlement resulted from gravity, where solid-phase particles with a large particle size in the drilling-fluid system, for example, the weighting material used under high-density conditions having a large particle size, tend to settle under gravity; the other is settlement resulted from an unstable fluid environment, specifically, because an oil-in-water drilling fluid is a thermodynamically unstable system, when the ambient temperature rises, on one hand, a high-density completion fluid tend to settle as the drilling fluid rheology deteriorates and the viscosity and shear force are reduced; and on the other hand, the high-density completion fluid tend to settle as the strength of the oil-water interfacial film decreases and the emulsification stability of the system is disrupted.

In order to overcome the difficulties of high-temperature settling of a completion fluid due to an unstable fluid environment, the present disclosure introduces a nanoemulsion as a stabilizer into the above oil-based completion fluid. In one aspect, the nanoparticles in the nanoemulsion have a surface effect and a small-size effect (small particle size and large specific surface area), which enable them to be adsorbed at the oil-water interface, further enhancing the strength of the oil-water interfacial film, and promoting a more even dispersion of dispersed-phase droplets (i.e. oil-in-water droplets) and solid-phase particles. At the same time, the emulsifying and wetting properties of the nanoemulsion itself can improve the surface properties of the solid-phase particles (e.g. barite) so that they can be better suspended in the oil phase. The addition of nanoemulsion stabilizer helps to improve the overall emulsion stability, dispersion stability and suspension stability of the system, thus avoiding the settling of the weighting material in the oil-based completion fluids at high temperatures and in a long-term static state.

In the above high-temperature-resistant, high-density, oil-based completion fluid, the primary emulsifier comprises a fatty acid amide compound having an appropriate acid value and a low amine value, which is advantageous in improving the emulsion stability. More specifically, the primary emulsifier may be obtained by a method of preparing the primary emulsifier DR-EM as disclosed in CN108048052A (application No.: 201711443636.3, Title of the Disclosure: A high-density oil-based drilling fluid resistant to salt and water intrusion and a method of preparation thereof, published on May 18, 2018), the entire contents of which is hereby incorporated as part of the present disclosure.

In the above high-temperature-resistant, high-density, oil-based completion fluid, said co-emulsifier comprises an alkanolamide compound, which is a compound containing both a hydroxyl and an amide group at the hydrophilic end, having both emulsifying and wetting functions. Specifically, the co-emulsifier may be obtained by a method of preparing the co-emulsifier DR-CO as disclosed in CN108048052A (application No.: 201711443636.3, Title of the Disclosure: A high-density oil-based drilling fluid resistant to salt and water intrusion and a method of preparation thereof, published on May 18, 2018), the entire contents of which is hereby incorporated as part of the present disclosure.

In the above high-temperature-resistant, high-density, oil-based completion fluid, the combination of the primary emulsifier and the co-emulsifier has a synergistic effect, which helps to improve the rheology and settlement stability of the high-density completion fluid (the density of the completion fluid in the present disclosure is as high as 2.60 g/cm³), and solves the technical problem that the existing emulsifiers adsorbs a large amount of barite and other weighting materials in a high-density drilling fluid/completion fluid, which leads to the precipitation of a large amount of barite or thickening of the drilling fluid/completion fluid under high temperature.

In the above high-temperature-resistant, high-density, oil-based completion fluid, the weighting material comprises one or a combination of two or more of barite powder, micro-manganese, micronized barite and the like. Here, the barite powder is generally a barite powder having a density of 4.25 g/cm³ or more, for example a density of 4.3 g/cm³ or more, and the micronized barite is generally a micronized barite having a D₉₀ of 10 μm or less.

In the present disclosure, it was found that by compounding barite and micronized barite, the size of suspended particles in the completion fluid can be reduced, thereby further improving the problem of settling of the weighting material in a long-term static state; particularly, when the temperature rises above 150° C., the compounding of the above two types of barites can effectively prevent the problem of settling of the completion fluid arising from long-term static storage in a high-temperature environment. In a specific embodiment of the present disclosure, the weighting material preferably comprises a mixture of barite powder and micronized barite. The mixture of barite powder and micronized barite preferably comprises 5-10 parts by mass of barite powder and 0-5 parts (e.g. greater than 0 part, less than or equal to 5 parts) by mass of micronized barite.

In the above high-temperature-resistant, high-density, oil-based completion fluid, the base oil generally comprises one or a combination of two or more of white oil, diesel oil, and gas-to-liquid oil.

In the above high-temperature-resistant, high-density, oil-based completion fluid, the aqueous solution of salt has a mass concentration of generally 10-30%.

In the above high-temperature-resistant, high-density, oil-based completion fluid, the salt comprises an inorganic salt and/or an organic salt, and the like.

In the above high-temperature-resistant, high-density, oil-based completion fluid, the organic salt comprises acetate, formate and the like. The acetate comprises sodium acetate and the like.

In the above high-temperature-resistant, high-density, oil-based completion fluid, the inorganic salt comprises an inorganic chloride salt or the like.

In the above high-temperature-resistant, high-density, oil-based completion fluid, the inorganic chloride salt may be an alkali metal chloride, an alkaline earth metal chloride, or the like. Specifically, said inorganic chloride salt may comprise one or a combination of two or more of sodium chloride, calcium chloride, potassium chloride and the like.

In the above high-temperature-resistant, high-density, oil-based completion fluid, the inorganic chloride salt may comprise one or a combination of two or more of sodium chloride, calcium chloride, potassium chloride and the like.

According to a specific embodiment of the present disclosure, when the inorganic salt is an inorganic chloride salt, the completion fluid comprises: 200-240 parts of base oil, 2-28 parts of a primary emulsifier, 1-12 parts of a co-emulsifier, 10-60 parts of an aqueous solution of an inorganic chloride salt, 0.5-10 parts of organic soil (e.g., 0.5-8 parts), 3-16 parts of an alkalinity regulator, 2-18 parts of a filtrate reducer, 1-16 parts of a stabilizer, 300-1350 parts (e.g., 500-1200 parts) of a weighting material; wherein the stabilizer comprises the aforementioned nanoemulsion. The mass concentration of the aqueous solution of the inorganic chloride salt is generally 10-30%.

In the above high-temperature-resistant, high-density, oil-based completion fluid, the organic soil may comprise a lipophilic clay. The lipophilic clay may be bentonite treated with a modifier, and a surfactant and/or a silane coupling agent may be used for the modifier; e.g. the modifier may comprise one or a combination of two or more of cetyltrimethylammonium bromide, octadecyltrimethylammonium chloride, KH570 and KH550. Preferably, the modifier comprises a combination of at least one of cetyltrimethylammonium bromide and octadecyltrimethylammonium chloride and at least one of KH570 and KH550. Here, KH550 is γ-aminopropyltriethoxysilane, and KH570 is γ-methacryloxypropyltrimethoxysilane.

In the above high-temperature-resistant, high-density, oil-based completion fluid, preferably the high-temperature-resistant, high-density, oil-based completion fluid comprises, by weight, 0.5-8 parts of organic soil, preferably 1.5-4.5 parts of organic soil. That is, the completion fluid comprises, by weight, 200-240 parts of base oil, 2-28 parts of a primary emulsifier, 1-12 parts of a co-emulsifier, 10-60 parts of an aqueous solution of salt, 0.5-8 parts, preferably 1.5-4.5 parts of the organic soil, 3-16 parts of an alkalinity regulator, 2-18 parts of a filtrate reducer, 1-16 parts of a stabilizer, and 300-1350 parts, e.g. 500-1200 parts of a weighting material. Further, when the salt is an inorganic chloride salt, the completion fluid comprises, by weight, 200-240 parts of base oil, 2-28 parts of a primary emulsifier, 1-12 parts of a co-emulsifier, 10-60 parts of an aqueous solution of the inorganic chloride salt, 0.5-8 parts, preferably 1.5-4.5 parts of the organic soil, 3-16 parts of an alkalinity regulator, 2-18 parts of a filtrate reducer, 1-16 parts of a stabilizer, and 300-1350 parts, for example 500-1200 parts of a weighting material.

In the above high-temperature-resistant, high-density, oil-based completion fluid, the alkalinity regulator may comprise calcium oxide, magnesium oxide and the like. For example, the alkalinity regulator may be calcium oxide.

In the above high-temperature-resistant, high-density, oil-based completion fluid, the filtrate reducer may comprise one or a combination of two or more of oxidized asphalt, organic lignite and humic acid amide resins and the like. For example, the filtrate reducer may comprise oxidized bitumen and/or organic lignite.

According to a specific embodiment of the present disclosure, the density of the above high-temperature-resistant, high-density, oil-based completion fluid may be up to 1.5-2.6 g/cm³ (1.50-2.60 g/cm³).

According to a specific embodiment of the present disclosure, the above method of preparing a high-temperature-resistant, high-density, oil-based completion fluid may include: while maintaining a certain mixing speed (for example, optionally 11000-12000 rpm), adding a primary emulsifier and a co-emulsifier to a base oil and mixing evenly (for a duration of optionally 10 minutes); adding an organic soil and mixing evenly (for a duration of optionally 5-10 minutes); adding an aqueous solution of a salt (for example, an inorganic chlorine salt aqueous solution) and mixing evenly (for a duration of optionally 20 minutes); adding an alkalinity regulator and mixing evenly (for a duration of optionally 5-10 minutes); adding a filtrate reducer and mixing evenly (for a duration of optionally 5-10 minutes); adding a stabilizer and mixing evenly (for a duration of optionally 10-20 minutes); and then adding an weighting material and mixing evenly (for a duration of optionally 20-30 minutes), so as to obtain the high-temperature-resistant, high-density, oil-based completion fluid.

The present disclosure also provides the use of the above high-temperature-resistant, high-density, oil-based completion fluids in the development of drilling and completion of a deep well, an ultra-deep well, a high-density well, a high-temperature and high-pressure well, and a complex well containing a thick salt-gypsum layer and/or a high-pressure brine layer.

According to a specific embodiment of the present disclosure, the high-temperature-resistant, high-density, oil-based completion fluid of the present disclosure is suitable for use in the construction of a drilling and completion development under the formation conditions of a temperature of 200° C. or more, a pressure of 200 MPa or more, and/or a thickness of the salt-gypsum layer of 4,500 m or more.

The present disclosure has the following beneficial effects:

1. The nanoemulsion provided by the present disclosure can be used as a stabilizer for high-temperature-resistant, high-density, oil-based completion fluid, and can effectively improve the settlement stability, emulsification stability, rheological stability and filtration loss reduction of the oil-based completion fluid under high temperature and high pressure.

2. The high-temperature-resistant, high-density, oil-based completion fluid provided by the present disclosure has a density of up to 2.60 g/cm³, an anti-brine intrusion ratio of up to 50%, an SF of<0.53 (or even<0.52) when standing at constant temperature at 200° C. for more than 15 days, and high-temperature and high-pressure filtration loss of less than 5 ml. It has high resistance to brine intrusion, good emulsion stability and high-temperature settlement stability performance, and is suitable for the development of drilling and completion of deep and ultra-deep wells at high temperature (200° C. or above), high pressure (200 MPa or more), with presence of a thick salt-gypsum layer (4,500 m or more) and/or a high-pressure brine layer.

3. The high-temperature-resistant, high-density, oil-based completion fluid provided by the present disclosure has a simple on-site process, and does not require a switching of systems and stall the project progress especially for drilling of complex wells such as deep wells and ultra-deep wells using oil-based drilling fluid. It can be recovered and recycled, which improves the efficiency of the development of oil and gas fields, and can meet the requirements of drilling and completion projects of complex deep wells with high temperature, high density, and high brine intrusion.

### DESCRIPTION OF THE DRAWINGS

FIG. 1 shows the test results of the droplet particle size of a water-in-oil emulsion without a stabilizer and a water-in-oil emulsion with a stabilizer in Test Example 4.

### DETAILED DESCRIPTION OF THE INVENTION

In order to have a better understanding of the technical features, purposes and beneficial effects of the present disclosure, the technical solutions of the present disclosure are described in detail below in connection with specific examples, and it should be understood that these examples are only used to illustrate the present disclosure and are not intended to limit the scope of the present disclosure. In the examples, the raw reagents and materials are commercially available, and for experimental methods without specified conditions, conventional methods and conditions well known in the related filed or conditions recommended by the instrument manufacturer are used.

### Example 1

This example provides a high-temperature-resistant, high-density, oil-based completion fluid, the preparation method of which comprised:

### 1. Preparation of Stabilizer:

70 g of divinyl dimethyl silane and 10 g of diphenyl chloromethane were sequentially added into a 250 ml three-necked flask, and n-butylamine was slowly added dropwise as a catalyst to the flask under the condition of 200 r/min and 60° C. The mixture was continued to be heated up to 90° C., ammonium persulphate was added as an initiator, and the speed of rotation was increased to 300 r/min to conduct a reaction for 5 hours. After the reaction was completed, the mixture was removed and cooled to obtain a high-temperature-resistant cross-linking agent.

55 g of styrene, 1.4 g of acrylic acid, 5 g of methyl methacrylate, 90 g of distilled water, 4 g of the high-temperature-resistant cross-linking agent, 0.01 g of sodium bicarbonate, 4 g of alkylphenol sulfonate polyoxyethylene ether phosphate salt, and 0.03 g of tertiary dodecanethiol were mixed, and emulsified with high-speed stirring for 30 minutes to obtain a pre-emulsion.

30% by volume of the pre-emulsion was transferred into a reaction vessel, and nitrogen was charged in the reaction vessel, with a stirring rate set to 200 r/min. The temperature was slowly raised to 65° C., and 15 g of a potassium persulfate solution at a concentration of 3 wt. % was slowly added dropwise (finished after 4 hours). After 1 hour of reaction, the remaining pre-emulsion was added dropwise while the temperature was raised to 72-75° C. for 3 hours of reaction. Then, the temperature was raised to 76-80° C. and the reaction continued for 2-3 hours. After cooling and adjusting the pH to 7-8 by adding aqueous ammonia, a nanoemulsion was obtained.

### 2. Preparation of Oil-Based Completion Fluid

While keeping a stirring speed of 11,000 rpm, 10 g of a fatty acid amide compound as a primary emulsifier (primary emulsifier DR-EM) and 10 g of an alkanolamide compound as a co-emulsifier (co-emulsifier DR-CO) were added to 212 g diesel, and stirred at high speed for 10 minutes; 3 g of organic soil was added with stirring at high speed for 10 minutes; 45 g of an aqueous CaCl₂ solution (at a mass concentration of 20%) was added with stirring at high speed for 20 minutes; 12 g of calcium oxide was added with stirring at high speed for 10 minutes; 10 g of oxidized asphalt was added with stirring at high speed for 10 minutes; 8 g of the nanoemulsion prepared in Step 1 was added as a stabilizer with stirring at high speed for 10 minutes; and finally, 504 g of barite with a density of 4.25 g/cm³ was added with stirring for 30 minutes, to obtain a high-temperature-resistant, high-density, oil-based completion fluid with a density of 1.80 g/cm³.

### Example 2

This example provides a high-temperature-resistant, high-density, oil-based completion fluid, with the composition of components and the preparation method thereof essentially the same as those in Example 1, except that in Step 2, 454 g of barite (with a density of 4.25 g/cm³) and 50 g of micronized barite (with a D₉₀ of 10 μm or less) were used in this example instead of 504 g of barite in Example 1. The high temperature, high-density oil-based completion fluid prepared in this example had a density of 1.80 g/cm³.

### Example 3

### 1. Preparation of Stabilizer:

70 g of divinyl dimethyl silane and 10 g of diphenyl chloromethane were sequentially added into a 250 ml three-necked flask, and n-butylamine was slowly added dropwise as a catalyst to the flask under the condition of 200 r/min and 60° C. The mixture was continued to be heated up to 90° C., ammonium persulphate was added as an initiator, and the speed of rotation was increased to 300 r/min to conduct a reaction for 5 hours. After the reaction was completed, the mixture was removed and cooled to obtain a high-temperature-resistant cross-linking agent.

48 g of styrene, 3 g of methacrylic acid, 10 g of butyl methacrylate, 70 g of distilled water, 6 g of the high-temperature-resistant cross-linking agent, 0.02 g of sodium bicarbonate, 4 g of alkyl alcohol amide phosphate, and 0.02 g of tert-octadecanethiol were mixed, and emulsified with high-speed stirring for 30 min to obtain a pre-emulsion.

30% by volume of the pre-emulsion was transferred into a reaction vessel, and nitrogen was charged into the reaction vessel, with a stirring rate set to 200 r/min. The temperature was slowly raised to 65° C., and 15 g of potassium persulfate solution with a concentration of 3 wt. % was slowly added dropwise (finished in 4 hours). After 1 h of reaction, the remaining pre-emulsion was added dropwise while the temperature was raised to 72-75° C. for 3 hours of reaction. Then, the temperature was raised to 76-80° C. and the reaction continued for 2-3 hours. After cooling and adjusting the pH to 7-9 by adding aqueous ammonia, a nanoemulsion was obtained.

### 2. Preparation of Oil-Based Completion Fluid

While keeping a stirring speed of 11,000 rpm, 18 g of a fatty acid amide compound as a primary emulsifier (primary emulsifier DR-EM) and 10 g of an alkanolamide compound as a co-emulsifier (co-emulsifier DR-CO) were added to 212 g diesel, and stirred at high speed for 10 minutes; 8 g of organic soil was added with stirring at high speed for 10 minutes; 45 g of an aqueous CaCl₂ solution (at a mass concentration of 20%) was added with stirring at high speed for 20 minutes; 12 g of calcium oxide was added with stirring at high speed for 10 minutes; 12 g of oxidized asphalt was added with stirring at high speed for 10 minutes; 10 g of the nanoemulsion prepared in Step 1 was added as a stabilizer with stirring at high speed for 10 minutes; and finally, 477 g of barite (with a density of 4.25 g/cm³) and 53 g of micronized barite (with a D₉₀ of 10 μm or less) was added with stirring for 30 minutes, to obtain a high-temperature-resistant, high-density, oil-based completion fluid with a density of 2.0 g/cm³.

### Example 4

This example provided a high-temperature-resistant, high-density, oil-based completion fluid, with the composition of components and the preparation method thereof essentially the same as those in Example 3, except that in Step 2, 551 g of barite (with a density of 4.25 g/cm³) and 137 g of micronized barite (with a D₉₀ of 10 μm or less) were used in this example instead of 477 g of barite and 53 g of micronized barite in Example 3, and 10 g of organic soil was added. The high temperature, high-density oil-based completion fluid prepared in this example had a density of 2.20 g/cm³.

### Example 5

### 1. Preparation of Stabilizer:

The process was the same as the process of preparing the stabilizer in Example 3.

### 2. Preparation of Oil-Based Completion Fluid

While keeping a stirring speed of 11,000 rpm, 18 g of a fatty acid amide compound as a primary emulsifier (primary emulsifier DR-EM) and 12 g of an alkanolamide compound as a co-emulsifier (co-emulsifier DR-CO) were added to 228 g diesel, and stirred at high speed for 10 minutes; 10 g of organic soil was added with stirring at high speed for 10 minutes; 15 g of an aqueous CaCl₂ solution (at a mass concentration of 20%) was added with stirring at high speed for 20 minutes; 10 g of calcium oxide was added with stirring at high speed for 10 minutes; 8 g of oxidized asphalt was added with stirring at high speed for 10 minutes; 10 g of the nanoemulsion prepared in Step 1 was added as a stabilizer with stirring at high speed for 10 minutes; and finally, 692 g of barite (with a density of 4.25 g/cm³) and 244 g of micronized barite (with a D₉₀ of 10 μm or less) was added with stirring for 30 minutes, to obtain a high-temperature-resistant, high-density, oil-based completion fluid with a density of 2.40 g/cm³.

### Example 6

### 1. Preparation of Stabilizer:

The process was the same as the process of preparing the stabilizer in Example 3.

### 2. Preparation of Oil-Based Completion Fluid

While keeping a stirring speed of 11,000 rpm, 18 g of a fatty acid amide compound as a primary emulsifier (primary emulsifier DR-EM) and 12 g of an alkanolamide compound as a co-emulsifier (co-emulsifier DR-CO) were added to 216 g diesel, and stirred at high speed for 10 minutes; 10 g of organic soil was added with stirring at high speed for 10 minutes; 30 g of an aqueous CaCl₂ solution (at a mass concentration of 20%) was added with stirring at high speed for 20 minutes; 15 g of calcium oxide was added with stirring at high speed for 10 minutes; 8 g of oxidized asphalt was added with stirring at high speed for 10 minutes; 12 g of the nanoemulsion prepared in Step 1 was added as a stabilizer with stirring at high speed for 10 minutes; and finally, 910 g of barite (with a density of 4.25 g/cm³) and 212 g of micronized barite (with a D₉₀ of 10 μm or less) was added with stirring for 30 minutes, to obtain a high-temperature-resistant, high-density, oil-based completion fluid with a density of 2.60 g/cm³.

### Example 7

### 1. Preparation of Stabilizer:

The process was the same as the process of preparing the stabilizer in Example 3.

### 2. Preparation of Oil-Based Completion Fluid

While keeping a stirring speed of 11,000 rpm, 15 g of a fatty acid amide compound as a primary emulsifier (primary emulsifier DR-EM) and 6 g of an alkanolamide compound as a co-emulsifier (co-emulsifier DR-CO) were added to 200 g 3 #white oil, and stirred at high speed for 10 minutes; 6 g of organic soil was added with stirring at high speed for 10 minutes; 60 g of an aqueous CaCl₂ solution (at a mass concentration of 20%) was added with stirring at high speed for 20 minutes; 12 g of calcium oxide was added with stirring at high speed for 10 minutes; 8 g of oxidized asphalt was added with stirring at high speed for 10 minutes; 6 g of the nanoemulsion prepared in Step 1 was added as a stabilizer with stirring at high speed for 10 minutes; and finally, 175 g of barite (with a density of 4.30 g/cm³) and 173 g of micronized barite (with a D₉₀ of 10 μm or less) was added with stirring for 30 minutes, to obtain a high-temperature-resistant, high-density, oil-based completion fluid with a density of 1.60 g/cm³.

### Comparative Example 1

This Comparative Example provides an oil-based completion fluid, with the composition of components and the preparation method thereof essentially the same as those in Example 3, except that in this Comparative Example a nanoemulsion was neither prepared, nor added as a stabilizer to the oil-based completion fluid.

### Comparative Example 2

This Comparative Example provides an oil-based completion fluid, with the composition of components and the preparation method thereof essentially the same as those in Example 3, except that no cross-linking agent is prepared and added during the preparation of the stabilizer in Step 1 in this Comparative Example.

### Comparative Example 3

This Comparative Example provides an oil-based completion fluid, with the composition of components and the preparation method thereof essentially the same as those in Example 3, except that the cross-linking agent added during the preparation of the stabilizer in Step 1 in this Comparative Example was a commonly used cross-linking agent, N,N′-methylenebisacrylamide.

### Comparative Example 4

This Comparative Example provides an oil-based completion fluid, with the composition of components and the preparation method thereof essentially the same as those in Example 3, except that the emulsifier added during the preparation of the stabilizer in Step 1 of this Comparative Example was a commonly used emulsifier, OP-10.

### Test Example 1

This test example provides the results of a rolling-aging test on the oil-based completion fluids prepared in Examples 1 to 7 and Comparative Examples 1 to 4. The test method was as follows: rolling and aging the oil-based completion fluid samples at 200° C. for 16 hours, and evaluating the basic performance before and after the rolling-aging according to the measurement procedure in “GB/T16783.2-2012; Petroleum and natural gas industries—Field testing of drilling fluids—Part 2: Oil-based fluids”. The test results are shown in Table 1.

In the following Tables 1 and 2, ρ is the density of drilling fluid; AV is the apparent viscosity; PV is the plastic viscosity; YP is the dynamic shear force; Φ6/Φ3 are the readings of a six-speed rotational viscometer at 6 rpm and 3 rpm; ES is the value of the emulsion breaking voltage; GEL is the initial/final gel strength, and FLHTHP is the high temperature and high pressure filtration loss.

TABLE 1

| | | | | | | | FL_{HTHP} | |
|---|---|---|---|---|---|---|---|---|
| | | ρ | AV | PV | YP | GEL | (180° C.) | ES |
| Test sample | | (g/cm³) | mPa · s | mPa · s | Pa | Pa/Pa | ml | (V) |
| Example 1 | before | 1.80 | 48 | 40 | 8 | 5/6.5 | — | 1031 |
| | rolling | | | | | | | |
| | after | 1.80 | 44 | 37 | 7 | 3/5 | 1.8 | 1706 |
| | rolling | | | | | | | |
| Example 2 | before | 1.80 | 47 | 38 | 9 | 5/7 | — | 1173 |
| | rolling | | | | | | | |
| | after | 1.80 | 51 | 37 | 14 | 6/9 | 2.0 | 1889 |
| | rolling | | | | | | | |
| Example 3 | before | 2.00 | 56 | 44 | 12 | 6/9.5 | — | 1173 |
| | rolling | | | | | | | |
| | after | 2.00 | 65.5 | 49 | 16.5 | 8/12 | 2.6 | 1683 |
| | rolling | | | | | | | |
| Example 4 | before | 2.20 | 68.5 | 55 | 13.5 | 7/11 | — | 1247 |
| | rolling | | | | | | | |
| | after | 2.20 | 77.5 | 60.5 | 17 | 10/13.5 | 2.8 | 1756 |
| | rolling | | | | | | | |
| Example 5 | before | 2.40 | 69.5 | 62 | 7.5 | 4/6 | — | 2000 |
| | rolling | | | | | | | |
| | after | 2.40 | 79 | 70 | 9 | 5/7 | 3.6 | 2000 |
| | rolling | | | | | | | |
| Example 6 | before | 2.60 | 99.5 | 79.5 | 20 | 10/16.5 | — | 1225 |
| | rolling | | | | | | | |
| | after | 2.60 | 109.5 | 87 | 22.5 | 13/18 | 4.8 | 1692 |
| | rolling | | | | | | | |
| Example 7 | before | 1.60 | 46 | 33 | 13 | 6/9 | — | 1104 |
| | rolling | | | | | | | |
| | after | 1.60 | 73 | 57 | 16 | 6/10 | 1.0 | 1450 |
| | rolling | | | | | | | |
| Comparative | before | 2.00 | 45 | 40 | 5 | 2/4 | — | 826 |
| Example 1 | rolling | | | | | | | |
| | after | 2.00 | 42 | 39 | 3 | 2/3 | 5.8 | 1245 |
| | rolling | | | | | | | |
| Comparative | before | 2.00 | 49 | 41 | 8 | 4/7 | — | 856 |
| Example 2 | rolling | | | | | | | |
| | after | 2.00 | 46 | 43 | 3 | 2/4 | — | 1027 |
| | rolling | | | | | | | |
| Comparative | before | 2.00 | 55 | 45 | 10 | 5/8.5 | — | 955 |
| Example 3 | rolling | | | | | | | |
| | after | 2.00 | 44.5 | 41 | 3.5 | 2.5/4 | — | 1105 |
| | rolling | | | | | | | |
| Comparative | before | 2.00 | 56 | 45 | 11 | 5/9 | — | 1265 |
| Example 4 | rolling | | | | | | | |
| | after | 2.00 | 46.5 | 42 | 4.5 | 3/5 | 9.0 | 865 |
| | rolling | | | | | | | |

As can be seen from Table 1, the density of the high-temperature-resistant, high-density, oil-based completion fluids prepared in Example 1 to Example 7 can reach up to 2.6 g/cm³, and the viscosity, static shear force and dynamic shear force of the completion fluids in Example 1 to Example 7 increased with the increase of density after rolling-aging at a high temperature of 200° C., and they maintained a high gel strength, with an ES of more than 1,000 V, and a high-temperature and high-pressure filtration loss of less than 5 ml, indicating that the high-temperature-resistant, high-density, oil-based completion fluid of the present disclosure had good rheological and emulsification stability, which ensured that it did not settle after a long period of high-temperature resting, while its good reduction of filtration loss was favorable to the protection of the reservoir. The completion fluid with no stabilizer added of Comparative Example 1 had lower shear force and gel strength before and after aging, and an increased filtration loss. The completion fluid of Comparative Example 2 was added with a stabilizer which was prepared without cross-linking, and had lower shear force and gel strength before and after ageing compared to that of Example 3. The completion fluid of Comparative Example 3 was added with a stabilizer, but the cross-linking agent used in the preparation of the stabilizer was a conventional cross-linking agent, and although it had shear force and gel strength comparable to those of Example 3 before aging, the shear force and gel strength were substantially reduced after aging, suggesting that the stabilizer was ineffective in improving the rheological stability of the completion fluid at high temperature. The completion fluid of Comparative Example 4 was added with a stabilizer, but the emulsifier used in the preparation of the stabilizer was a conventional emulsifier, and although it had shear force and gel strength comparable to those of Example 3 before aging, the shear force and gel strength were substantially reduced after aging, suggesting that the stabilizer was ineffective in improving the rheological stability of the completion fluid at high temperature, acted adversely on the filtration loss reduction of the system, and was insufficient to maintain the long-term high temperature settlement stability of the system.

### Test Example 2

This test example provides the results of a brine intrusion contamination experiment on the high-temperature-resistant, high-density, oil-based drilling fluid of Example 5, where the brine used was a composite brine (350 g of sodium chloride (analytically pure) and 20 g of calcium chloride (analytically pure) were weighed and dissolved in 1,000 ml of distilled water, and was stirred to complete dissolution with a glass rod to obtain the composite brine). Table 2 shows the results of changes in the performance of the completion fluid after the brine intrusion in different proportions. In Table 2, brine addition=brine volume/completion fluid volume in %.

TABLE 2

| | ρ | AV | PV | YP | | ES |
|---|---|---|---|---|---|---|
| Brine addition (%) | (g/cm³) | mPa · s | mPa · s | Pa | Φ6/Φ3 | (V) |
| 0 | 2.40 | 69.5 | 62 | 7.5 | 4/6 | 2000 |
| 10 | 2.32 | 65 | 57 | 8 | 4/6.5 | 1721 |
| 20 | 2.20 | 67 | 58 | 9 | 9/6 | 1571 |
| 30 | 2.08 | 75 | 63 | 12 | 11/8 | 1245 |
| 40 | 1.97 | 85 | 70 | 15 | 12/10 | 1023 |
| 50 | 1.86 | 101 | 80 | 21 | 18/13 | 875 |
| 60 | 1.73 | / | / | / | 21/19 | 584 |

Note:
Test rheological temperature of 65° C.

As can be seen from Table 2, with the increase of brine addition, the emulsion breaking voltage gradually decreased and the viscosity gradually increased. When the brine intrusion ratio was greater than 50%, the fluidity was gradually lost. The above results indicate that the high-temperature-resistant, high-density, oil-based drilling fluid provided by the present disclosure has a brine intrusion resistance ratio of up to 50%.

### Test Example 3

This test example provides the results of high temperature settlement stability testing of the oil-based completion fluids prepared in Example 2, Example 3, Example 6, Example 7, and Comparative Examples 1 to 4. The test method was as follows: keeping each sample of the completion fluid at 200° C. for 3, 7, 10 and 15 days, and then probing the bottom with a glass rod and documenting the experimental phenomena. The static settlement stability of the drilling and completion fluid was evaluated by measuring the density difference between the upper and lower layers of the completion fluid: first, the completion fluid was added into a stainless steel tank, and after a period of static placement at a specific temperature, the density of the upper part of the drilling and completion fluid column (the lower layer of free liquid), Σₜₒₚ, and the density at the bottom, Σ_{bottom}, were measured, so as to obtain the difference in density of the upper and lower layers, i.e., the difference in static density, with the magnitude of the static stability of the static settling expressed by the static settling factor SF, SF=Σ_{bottom}/(Σ_{bottom+Σ}ₜₒₚ). The closer the value of the static settling factor was to 0.5, the better the settlement stability was, and otherwise the worse the settlement stability of the completion fluid was. Table 3 shows the results of the oil-based completion fluid settlement stability test.

TABLE 3

| | | Description of phenomenon | | |
|---|---|---|---|---|
| | | Whether the | Whether hard | |
| | | glass rod can | sediment | |
| | | freely land on | occurs at | |
| Test Sample | | the bottom | the bottom | SF |
| Example 2 | 3 d | Yes | No | 0.501 |
| | 7 d | Yes | No | 0.502 |
| | 10 d | Yes | No | 0.503 |
| | 15 d | Yes | No | 0.516 |
| Example 3 | 3 d | Yes | No | 0.502 |
| | 7 d | Yes | No | 0.502 |
| | 10 d | Yes | No | 0.512 |
| | 15 d | Yes | No | 0.521 |
| Example 6 | 7 d | Yes | No | 0.502 |
| | 10 d | Yes | No | 0.517 |
| | 15 d | Yes | No | 0.525 |
| Example 7 | 7 d | Yes | No | 0.500 |
| | 10 d | Yes | No | 0.500 |
| | 15 d | Yes | No | 0.501 |
| | 20 d | Yes | No | 0.510 |
| Comparative | 3 d | No | No, soft sediment of 7 cm | 0.684 |
| Example 1 | 7 d | No | Yes | / |
| Comparative | 3 d | No | No, soft sediment of 5 cm | 0.658 |
| Example 2 | 7 d | No | Yes | / |
| Comparative | 3 d | No | No, soft sediment of 4.5 cm | 0.645 |
| Example 3 | 7 d | No | Yes | / |
| Comparative | 3 d | No | No, soft sediment of 3.5 cm | 0.642 |
| Example 4 | 7 d | No | Yes | / |

As can be seen from Table 3, the oil-based completion fluids prepared in Example 2, Example 3, Example 6 and Example 7 of the present disclosure could be evaluated by the falling rod method after being left to stand at a high temperature of 200° C. for 15 days, and the glass rods could all land on the bottom freely and there is no hard sediment at the bottom; and the test static settlement factors SF of the above oil-based completion fluids were all less than 0.53, indicating that the oil-based completion fluids prepared in Example 2, Example 3, Example 6 and Example 7 of the present disclosure could be kept without settlement after being kept at high temperature for a long time. In contrast, for the completion fluid of Comparative Example with no stabilizer added, after being kept for 3 days at high temperature, the glass rod could not land on the bottom freely and there was a large amount of soft sediment at the bottom, and its static sedimentation factor SF was greater than 0.53. For the completion fluid of Comparative Example 2 in which a stabilizer prepared without cross-linking was added, after being kept for 3 days at high temperature, the glass rod could not land on the bottom freely and there was a large amount of soft sediment at the bottom. For the completion fluid of Comparative Example 3 in which a stabilizer prepared with a conventional cross-linking agent was added, after being kept for 3 days at high temperature, the glass rod could not land on the bottom freely and there was a large amount of soft sediment at the bottom. For the completion fluid of Comparative Example 4 in which a stabilizer prepared with a conventional emulsifier was added, after being kept for 3 days at high temperature, the glass rod could not land on the bottom freely and there was a large amount of soft sediment at the bottom. This suggests that the oil-based completion fluids of Comparative Examples 1 to 4 could not meet the requirements of no settlement during prolonged downhole operation at 200° C.

### Test Example 4

This test example provides stability testing of a water-in-oil emulsion system with or without a stabilizer.

Sample 1 (without stabilizer): a water-in-oil emulsion was obtained by mixing by mass 80 parts of diesel, 4 parts of a primary emulsifier, 4 parts of a co-emulsifier, and 20 parts of an aqueous calcium chloride solution (at a mass concentration of 20%) and designated Sample 1.

Sample 2 (with stabilizer): a water-in-oil emulsion was obtained by mixing by mass 80 parts of diesel, 4 parts of a primary emulsifier, 4 parts of a co-emulsifier, 4 parts of a nanoemulsion, and 20 parts of an aqueous calcium chloride solution (at a mass concentration of 20%) and designated Sample 2.

The primary emulsifier, the co-emulsifier and the nanoemulsion contained in Sample 1 and Sample 2 were the same as the primary emulsifier, the co-emulsifier and the nanoemulsion in Example 1.

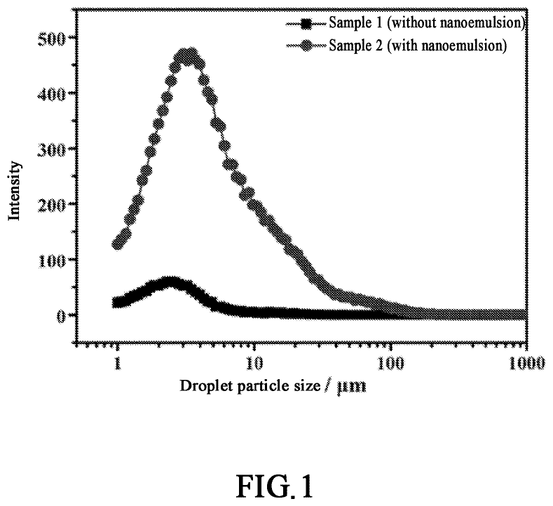

The droplet dispersion of Sample 1 and Sample 2 was tested using a Focused Beam Reflectometry (FBRM) instrument and the results are shown in FIG. 1. As can be seen from FIG. 1, the peak intensity of small-sized droplets (particle size<10 μm) in the water-in-oil emulsion is less than 100 without the addition of a nanoemulsion; the peak intensity of small-sized droplets in the water-in-oil emulsion increased drastically after the addition of the nanoemulsion. The results indicate that the nanoemulsion stabilizer provided by the present disclosure is effective in preventing the aggregation of droplets in a water-in-oil emulsion, thereby improving the stability of the water-in-oil emulsion.

### Test Example 5

This test example provide results of high temperature stability testing of different fatty acid-based emulsifiers.

5 groups of primary emulsifiers and co-emulsifiers were added to the same volume (240 mL) of 5 #white oil and were stirred with a variable frequency high-speed stirrer at 11,000 r/min for 20 minutes. 60 mL of 20% an aqueous calcium chloride solution were measured and slowly added to the above mixture and stirred with the variable frequency high-speed stirrer at 11,000 r/min for 20 minutes. 15.0 g of calcium oxide was weighed and added to the above mixing cup and stirred for 10 minutes at 11,000 r/min with the variable frequency high-speed stirrer to obtain a homogeneously dispersed emulsion. The emulsion breaking voltage of the above emulsion with the emulsifiers added before hot rolling, after hot rolling at 150° C., and after hot rolling at 180° C. was measured in accordance with GB/T 16783.2. The test results for each group of primary and co-emulsifier components and emulsion breaking voltage are summarized in Table 4.

TABLE 4

| | | | Amount of | | Emulsion breaking voltage (V) | | |
|---|---|---|---|---|---|---|---|
| | | | primary | Amount of co- | Before | After hot | After hot |
| | Primary | | emulsifier | emulsifier | hot | rolling at | rolling at |
| No. | emulsifier | Co-emulsifier | added (g) | added (g) | rolling | 150° C. | 180° C. |
| 1# | Primary | Co-emulsifier of | 12 | 0 | 473 | 744 | 978 |
| | emulsifier of | Example 1 | 0 | 12 | 580 | 556 | 743 |
| | Example 1 | | 6 | 6 | 650 | 527 | 847 |
| 2# | Fatty acid | Fatty acid amide | 12 | 0 | 598 | 438 | 379 |
| | derivative | derivative | 0 | 12 | 557 | 694 | 325 |
| | | | 6 | 6 | 497 | 293 | 282 |
| 3# | Amide lipid | Amido-amine | 12 | 0 | 732 | 655 | 386 |
| | | | 0 | 12 | 740 | 723 | 425 |
| | | | 6 | 6 | 573 | 595 | 325 |
| 4# | Modified fatty | Modified fatty | 12 | 0 | 801 | 655 | 384 |
| | acid amide | acid | 0 | 12 | 568 | 599 | 357 |
| | | | 6 | 6 | 546 | 666 | 282 |
| 5# | Polyamide | Amido-amine | 12 | 0 | 754 | 329 | 322 |
| | | | 0 | 12 | 492 | 345 | 403 |
| | | | 6 | 6 | 680 | 328 | 370 |

As seen from Table 4, compared to existing combinations of primary emulsifier and co-emulsifier, only the primary emulsifier and co-emulsifier provided by the present disclosure can simultaneously satisfy an emulsion breaking voltage of≥400 V after rolling the emulsifier at 180° C., and the primary and co-emulsifiers have a significant synergistic effect when used in combination than when each is used alone, suggesting that the combination of the primary emulsifier and the co-emulsifier provided by the present disclosure is useful for enhancing the high-temperature emulsification stability of an oil-based completion fluid system.

The above test results indicate that in the present disclosure, by adding a nanoemulsion as a stabilizer to an oil-based completion fluid, the emulsion stability and high-temperature-resistant settlement stability of the completion fluid can be improved. The oil-based completion fluid provided by the present disclosure has a density of up to 2.60 g/cm³, a high temperature and high pressure filtration loss of less than 5 ml, a brine intrusion resistance ratio of up to 50%, a SF<0.53 when standing at a constant temperature of 200° C. for more than 15 days, and is suitable for the development of drilling and completion of deep and ultra-deep wells at high temperature (200° C.), high pressure (200 MPa), with presence of a thick salt-gypsum layer (4,500 m) and/or a high-pressure brine layer.

1. A nanoemulsion, wherein raw materials for the nanoemulsion comprise a lipophilic alkenyl monomer, a hydrophilic alkenyl monomer, an emulsifier, a cross-linking agent, and water, wherein:
a mass ratio of the lipophilic alkenyl monomer, the hydrophilic alkenyl monomer, and the water is 1:(0.01-0.3):(0.1-5);
the mass of the emulsifier is 0.2-7% of the total mass of the lipophilic alkenyl monomer and the hydrophilic alkenyl monomer, and the mass of the cross-linking agent is 1-10% of the total mass of the lipophilic alkenyl monomer and the hydrophilic alkenyl monomer; and
the emulsifier comprises a phosphate-based emulsifier.

2. The nanoemulsion according to claim 1, wherein the nanoemulsion has nanoparticles having a particle size of 10 to 300 nm.

3. The nanoemulsion according to claim 1, wherein:
the lipophilic alkenyl monomer comprises a lipophilic alkene and/or a derivative of a lipophilic alkene; and
the hydrophilic alkenyl monomer comprises a hydrophilic alkene and/or a derivative of a hydrophilic alkene.

4. The nanoemulsion according to claim 1, wherein the emulsifier comprises one or a combination of two or more of an alkyl alcohol amide phosphate, an imidazoline-based phosphate, and an alkylphenol sulfonic acid polyoxyethylene ether phosphate salt.

5. The nanoemulsion according to claim 1, wherein:
the cross-linking agent comprises a compound produced by a reaction of divinyl dimethylsilane and diphenylchloromethane; and
the method of preparing the cross-linking agent comprises mixing divinyl dimethylsilane and diphenylchloromethane, raising the temperature to 60° C., adding a catalyst, then raising the temperature to 90° C., adding an initiator, and reacting, to obtain the cross-linking agent.

6. The nanoemulsion according to claim 1, wherein the mass of the cross-linking agent is 1-8% of the total mass of the lipophilic alkenyl monomer and the hydrophilic alkenyl monomer.

7. A high-temperature-resistant, high-density, oil-based completion fluid, comprising by weight 200-240 parts of base oil, 2-28 parts of a primary emulsifier, 1-12 parts of an co-emulsifier, 10-60 parts of an aqueous solution of a salt, 0.5-10 parts of organic soil, 3-16 parts of an alkalinity regulator, 2-18 parts of a filtrate reducer, 1-16 parts of a stabilizer, and 300-1350 parts of a weighting material, wherein the stabilizer comprises a nanoemulsion according to claim 1.

8. The high-temperature-resistant, high-density, oil-based completion fluid according to claim 7, wherein the completion fluid comprises by weight 200-240 parts of base oil, 2-28 parts of a primary emulsifier, 1-12 parts of a co-emulsifier, 10-60 parts of an aqueous solution of a salt, 0.5-10 parts of organic soil, 3-16 parts of an alkalinity regulator, 2-18 parts of a filtrate reducer, 1-16 parts of a stabilizer, and 500-1200 parts of a weighting material, wherein the stabilizer comprises a nanoemulsion according to claim 1.

9. The high-temperature-resistant, high-density, oil-based completion fluid according to claim 7, wherein the primary emulsifier comprises a fatty acid amide compound, and wherein the co-emulsifier comprises an alkanolamide compound containing both a hydroxyl group and an amide group at the hydrophilic end.

10. The high-temperature-resistant, high-density, oil-based completion fluid according to claim 7, wherein the weighting material comprises one or a combination of two or more of barite powder, micro-manganese, and micronized barite, wherein the barite powder has a density of 4.25 g/cm3 or more, and wherein the micronized barite has a D90 of 10 μm or less.

11. The high-temperature-resistant, high-density, oil-based completion fluid according to claim 10, wherein:
the weighting material comprises a mixture of barite powder and micronized barite; and
the mixture of barite powder and micronized barite comprises 5-10 parts by mass of barite powder and 0-5 parts by mass of micronized barite.

12. The high-temperature-resistant, high-density, oil-based completion fluid according to claim 7, wherein the base oil comprises one or a combination of two or more of white oil, diesel and gas-to-liquid oil.

13. The high-temperature-resistant, high-density, oil-based completion fluid according to claim 7, wherein the aqueous solution of a salt has a mass concentration of 10%-30%, and the salt comprises one or a combination of two or more of sodium chloride, calcium chloride, potassium chloride, and sodium acetate.

14. The high-temperature-resistant, high-density, oil-based completion fluid according to claim 7, comprising 1.5-4.5 parts by weight of the organic soil, wherein:
the organic soil comprises lipophilic clay;
the lipophilic clay comprises bentonite treated with a modifier; and
the modifier comprises one or a combination of two of a quaternary ammonium cationic surfactant and a silane coupling agent.

15. The high-temperature-resistant, high-density, oil-based completion fluid according to claim 14, wherein the modifier comprises one or a combination of two or more of cetyltrimethylammonium bromide, octadecyltrimethylammonium chloride, γ-aminopropyltriethoxysilane, and γ-methacryloyloxypropyltrimethoxysilane.

16. The high-temperature-resistant, high-density, oil-based completion fluid according to claim 14, wherein the modifier comprises a combination of at least one of cetyltrimethylammonium bromide and octadecyltrimethylammonium chloride with at least one of γ-aminopropyltriethoxysilane and γ-methacryloxypropyltrimethoxysilane.

17. The high-temperature-resistant, high-density, oil-based completion fluid according to claim 7, wherein the alkalinity regulator comprises calcium oxide and/or magnesium oxide.

18. The high-temperature-resistant, high-density, oil-based completion fluid according to claim 7, wherein the filtrate reducer comprises one or a combination of two or more of oxidized bitumen, organic lignite and humic acid amide resin.

19. The high-temperature-resistant, high-density, oil-based completion fluid according to claim 7, wherein the completion fluid has a density of 1.5-2.6 g/cm3.

20. A method of drilling or completing a well selected from a deep well, an ultra-deep well, a high-density well, a high-temperature and high-pressure well, or a complex well containing a thick salt-gypsum layer and/or a high-pressure brine layer comprising the step of directing the high-temperature-resistant, high-density, oil-based completion fluid according to claim 7 into the well.
